(19) United States
(12) Patent Application Publication
(10) Pub. No.: US 2026/0296393 A1
(43) Pub. Date: Oct. 1, 2026

(54) MOTOR VEHICLE PIPELINE AND METHOD FOR MANUFACTURING A MOTOR VEHICLE PIPELINE

(71) Applicant: TI Automotive (Fuldabrück) GmbH, Fuldabrück (DE)

(72) Inventors: Andreas Puhalla, Ettlingen (DE); Uwe Fiedler, Altlußheim (DE); Andre Häckel, Waldeck (DE); Georg Weick, Plankstadt (DE); Manuel Roeder, Rastatt (DE); Siegfried Arnold, Kassel (DE)

(21) Appl. No.: 19/631,837

(22) Filed: Mar. 27, 2026

(30) Foreign Application Priority Data
Apr. 1, 2025 (EP) 25167738.1

(51) Int. Cl. B60T 17/04; B32B 1/08; B32B 15/088; C08L 77/00; F16L 9/147

(52) U.S. Cl. CPC B60T 17/04; B32B 1/08; B32B 15/088; C08L 77/00; F16L 9/147; B32B 2250/02; B32B 2307/7376; B32B 2597/00

(57) ABSTRACT

A motor vehicle pipeline for conveying at least one fluid medium. The pipeline has a fluid channel and a pipe wall surrounding the fluid channel. The pipe wall has an inner pipe made of at least one metal and an outer layer made of at least one thermoplastic plastic that encases the inner pipe. At least one adhesion promoter layer made of at least one thermoplastic plastic is arranged between the inner pipe and the outer layer. The at least one thermoplastic plastic of the adhesion promoter layer is adhesion-modified, and for this purpose has at least one adhesion promoter group incorporated into the polymer structure and/or at least one adhesion promoter additive.

### RELATED APPLICATIONS

The present disclosure claims priority to and the benefit of European Application 25167738.1, filed on Apr. 1, 2025, the entire contents of each of which are incorporated herein by reference.

### FIELD

The present disclosure relates to a motor vehicle pipeline and method of manufacture, in particular to a brake line for motor vehicles, wherein the pipeline has a fluid channel and a pipe wall surrounding the fluid channel, and wherein the pipe wall has an inner pipe made of at least one metal and an outer layer made of at least one thermoplastic plastic that encases the inner pipe.

### BACKGROUND

Pipelines of the kind mentioned at the outset and methods for manufacturing such pipelines are basically known from practice in various embodiments. In particular, the fluid medium being passed through the motor vehicle pipeline is a hydraulic fluid, preferably a brake fluid, for example a polyglycol-based hydraulic fluid or brake fluid. However, other brake fluids and other fluids can basically also be passed through the fluid channel of the motor vehicle pipeline according to the present disclosure. In the following, just the term pipeline is used in reference to the expression motor vehicle pipeline.

Adhesion problems often arise when configuring the pipelines with an inner pipe made of at least one metal and an outer layer encasing the inner pipe made of at least one thermoplastic plastic. Therefore, in order to improve adhesion between the outer layer and the inner pipe, it is thus known from practice to first provide the inner pipe with a primer layer, and then apply the outer layer to this primer layer. The primer layers usually consist of a cured, thermosetting epoxy resin. However, we have found that applying these primer layers to the inner pipe is complicated, and in particular also expensive. For example, a comparatively large amount of solvent is generally required within the framework of application. The solvent must then be removed again to finish the primer layer. As a consequence, several work steps are required. In addition, the epoxy resin-based primer layers are disadvantageous from an environmental standpoint.

### BRIEF SUMMARY

The technical problem underlying the present disclosure is to indicate a motor vehicle pipeline of the kind mentioned at the outset, in which the disadvantages described above can be avoided, and in which in particular the adhesion between the inner pipe and the outer layer can be realized easily and functionally reliably and preferably with uncomplicated measures, while nonetheless meeting all requirements. In addition, the present disclosure is based on the technical problem of indicating a method for manufacturing a motor vehicle pipeline.

In order to solve the technical problem, the present disclosure teaches a motor vehicle pipeline, in particular a brake line for motor vehicles, for conveying at least one fluid medium, wherein the pipeline has a fluid channel and a pipe wall surrounding the fluid channel, wherein the pipe wall has an inner pipe made of at least one metal and an outer layer encasing the inner pipe made of at least one thermoplastic plastic, wherein at least one adhesion promoter layer made of at least one thermoplastic plastic is arranged between the inner pipe and the outer layer, characterized in that the at least one thermoplastic plastic of the adhesion promoter layer is adhesion-modified, and for this purpose has at least one adhesion promoter group and/or at least one adhesion promoter additive incorporated into the polymer structure. According to the present disclosure, the at least one thermoplastic plastic of the at least one adhesion promoter layer is an adhesion-modified thermoplastic plastic. Within the framework of the present disclosure, then, adhesion-modified thermoplastic plastic refers in particular to a thermoplastic plastic, which has at least one adhesion promoter group and/or at least one adhesion promoter additive incorporated into the polymer structure.

The present disclosure is based on the knowledge that the motor vehicle pipeline according to the present disclosure satisfies all requirements in terms of the adhesion between the outer layer and the inner pipe-due to the at least one adhesion promoter layer made of at least one adhesion-modified thermoplastic plastic interspersed according to the present disclosure. Modifying the adhesion of the at least one thermoplastic plastic of the adhesion promoter layer by means of at least one adhesion promoter group introduced into the polymer structure and/or by means of at least one adhesion promoter additive can ensure the adhesion between the inner pipe and the outer layer in a functionally reliable and less complicated manner. In particular the use of primer layers, for example based on epoxy resin, can here be forgone. This is very advantageous for production-related and cost reasons, and due to environmental aspects.

Within the framework of the present disclosure, the fact that the at least one thermoplastic plastic of the adhesion promoter layer is adhesion-modified by means of at least one adhesion promoter group incorporated into the polymer structure means in particular that the polymer structure of the thermoplastic plastic of the adhesion promoter layer is chemically modified by introducing at least one adhesion promoter group into the polymer structure. The at least one adhesion promoter group can be introduced into the polymer structure in particular via copolymerization and/or graft copolymerization and/or through substitution. Within the framework of the present disclosure, the fact that the at least one thermoplastic plastic of the adhesion promoter layer is adhesion-modified by means of at least one adhesion promoter additive means in particular that at least one adhesion promoter additive is added to the thermoplastic plastic of the adhesion promoter layer.

According to the present disclosure, the pipe wall has an inner pipe made of at least one metal. The inner pipe is preferably formed on the basis of at least one metal, with the inner pipe further preferably consisting of at least one metal or essentially of at least one metal. According to an embodiment, the inner pipe is formed on the basis of at least one alloy, and within the framework of this embodiment, it is preferred that the inner pipe consists or essentially consists of at least one alloy.

It is preferred that the inner pipe contains aluminum and/or zinc and/or iron, wherein the inner pipe is preferably formed on the basis of aluminum and/or on the basis of zinc and/or on the basis of iron, in particular on the basis of steel, wherein the inner pipe very preferably consists or essentially consists of aluminum and/or zinc and/or iron, in particular steel, and wherein the inner pipe very especially preferably consists or essentially consists of aluminum. It is preferred that the inner pipe consists or essentially consists of an aluminum alloy. The inner pipe very especially preferably consists of aluminum and/or an aluminum alloy or essentially consists of aluminum and/or an aluminum alloy.

Within the framework of the present disclosure, the fact that a wall component—in particular the inner pipe and/or the at least one adhesion promoter layer and/or the outer layer—of the pipeline is formed “on the basis of” a material means in particular that the wall component contains at least 50 wt.-% of this material. When reference is made here and below to the fact that a wall component of the pipeline “essentially consists” of a material, this means in particular that the wall component comprises at least 93 wt.-%, preferably at least 95 wt.-%, preferably at least 96 wt.-%, further preferably at least 97 wt.-%, very preferably at least 98 wt.-% and very especially preferably at least 99 wt.-% of the material. In particular, this takes into account the circumstance that a small quality of additives can be present apart from the mentioned material.

In a recommended embodiment of the pipeline according to the present disclosure, the inner pipe is in direct contact with the fluid carried in the fluid channel. Therefore, the inner pipe expediently forms the end of the pipeline toward the inside. However, it is basically also possible to inwardly provide additional layers or wall components that adjoin the inner pipe. It is further preferred that the outer layer forms the outwardly terminal layer of the pipeline according to the present disclosure. However, other outer layers can basically also outwardly adjoin the outer layer. It is further preferred that the at least one adhesion promoter layer according to the present disclosure outwardly adjoins the inner pipe. The at least one adhesion promoter layer is then in direct contact with the inner pipe, so that the inner pipe and the at least one adhesion promoter layer preferably touch each other in this preferred embodiment. It is further preferred that the outer layer outwardly adjoin the at least one adhesion promoter layer. As a consequence, the adhesion promoter layer and the outer layer preferably touch each other in such a preferred configuration. However, it is basically possible that additional layers be arranged between the inner pipe and the adhesion promoter layer and/or between the adhesion promoter layer and the outer layer. In particular, it is also possible for the pipeline according to the present disclosure to have at least two or at least three adhesion promoter layers, in particular adhesion promoter layers according to the present disclosure. In a very preferred embodiment of the present disclosure, the pipeline has a three-layer aggregate comprised of the inner pipe, an adhesion promoter layer outwardly adjoining the inner pipe, and an outer layer outwardly adjoining the adhesion promoter layer, without any other layers interspersed. The corresponding direct contact between the inner pipe and the adhesion promoter layer according to the present disclosure as well as between the adhesion promoter layer according to the present disclosure and the outer layer makes it possible to realize the adhesion of the outer layer to the inner pipe in a very functionally reliable manner.

A very especially preferable embodiment of the present disclosure is characterized in that the at least one thermoplastic plastic of the outer layer is at least one polypropylene, in particular at least one homo-polypropylene and/or at least one polypropylene copolymer. It is preferred that the outer layer consists or essentially consists of the at least one polypropylene.

A very preferred embodiment of the pipeline according to the present disclosure is characterized in that the at least one thermoplastic plastic of the outer layer is at least one polyamide, in particular at least one polyamide selected from the following group: “polyamide 6, polyamide 10, polyamide 11, polyamide 12, polyamide 6.6, polyamide 6.10, polyamide 6.12, polyamide 6.16, polyamide 10.10”, and is preferably polyamide 6.12 and/or polyamide 12. It is preferred that the outer layer consists or essentially consists of the at least one polyamide. According to a very preferred embodiment, the at least one thermoplastic plastic of the outer layer is polyamide 6.12 and/or polyamide 12, and the outer layer very especially preferably consists or essentially consists of polyamide 6.12 and/or polyamide 12.

It is very preferred that the at least one thermoplastic plastic of the outer layer is at least one polypropylene and/or at least one polyamide, in particular polyamide 6.12 and/or polyamide 12. The outer layer very preferably consists or essentially consists of the at least one polypropylene and/or the at least one polyamide, in particular of polyamide 6.12 and/or polyamide 12.

It is preferred that the at least one thermoplastic plastic of the outer layer contains at least one plastic recyclate, in particular at least one recyclate of the thermoplastic plastic of the outer layer. For example, if the thermoplastic plastic of the outer layer is polyamide 6.12 and/or polyamide 12 according to a preferred embodiment, the thermoplastic plastic preferably contains polyamide 6.12-recyclate and/or polyamide 12-recyclate. The thermoplastic plastic of the outer layer expediently contains at least 1 wt.-%, preferably at least 5 wt.-%, preferably at least 10 wt.-%, further preferably at least 20 wt.-%, very preferably at least 30 wt.-% of the recyclate. In particular, recyclate refers to a thermoplastic plastic that has already gone through a manufacturing process to yield a product, for example an intermediate product or end product, and is recycled as plastic waste. It is also possible that the thermoplastic plastic was scrap during a manufacturing process to be involved. Within the framework of the present disclosure, the term recyclate comprises in particular plastic waste from industrial manufacture (post-industrial recyclate, PIR) and/or post-consumer recyclates (PCR).

It is preferred that the at least one thermoplastic plastic of the outer layer is produced on the basis of plant or renewable raw material. The at least one thermoplastic plastic of the outer layer is preferably produced on the basis of biomass. The at least one thermoplastic plastic of the outer layer is further preferably produced exclusively or essentially exclusively on the basis of plant or renewable raw materials, in particular exclusively or essentially exclusively on the basis of biomass.

Within the framework of the present disclosure, it is very preferred that the at least one thermoplastic plastic of the adhesion promoter layer is at least one polypropylene, in particular at least one homo-polypropylene and/or at least one polypropylene copolymer. Within the framework of this preferred embodiment, the polypropylene, in particular the homo-polypropylene and/or the polypropylene copolymer, of the adhesion promoter layer is adhesion-modified. It is very preferred that the adhesion promoter layer consists or essentially consists of the adhesion-modified thermoplastic plastic, in particular of the adhesion-modified polypropylene, preferably of the adhesion-modified homo-polypropylene and/or of the adhesion-modified polypropylene copolymer.

According to a preferred embodiment of the present disclosure, the at least one thermoplastic plastic of the adhesion promoter layer is at least one polyamide, in particular at least one polyamide selected from the group: “polyamide 6, polyamide 10, polyamide 11, polyamide 12, polyamide 6.6, polyamide 6.10, polyamide 6.12, polyamide 6.16, polyamide 10.10”, and is preferably polyamide 6.12 and/or polyamide 12. Within the framework of this preferred embodiment, the polyamide of the adhesion promoter layer is adhesion-modified. It is especially preferred that the adhesion promoter layer consists or essentially consists of the at least one adhesion-modified thermoplastic plastic, in particular of the adhesion-modified polyamide, preferably of the adhesion-modified polyamide 6.12 and/or of the adhesion-modified polyamide 12.

It is very preferred that the at least one thermoplastic plastic of the adhesion promoter layer is at least one polypropylene and/or at least one polyamide, in particular polyamide 6.12 and/or polyamide 12. The adhesion promoter layer very especially preferably consists or essentially consists of the at least one adhesion-modified polypropylene and/or the at least one adhesion-modified polyamide, in particular the adhesion-modified polyamide 6.12 and/or the adhesion-modified polyamide 12.

If according to a preferred embodiment of the present disclosure, the at least one thermoplastic plastic of the outer layer is at least one polypropylene, and if the outer layer especially preferably consists or essentially consists of the at least one polypropylene, it is very preferred that the at least one thermoplastic plastic of the adhesion promoter layer is at least one polypropylene. In this conjunction, it is further preferred that the adhesion promoter layer then consists or essentially consists of the at least one adhesion-modified polypropylene. As a result—in particular due to the varietal uniformity—the adhesion between the adhesion promoter layer and the outer layer can be further improved.

If according to a preferred embodiment of the present disclosure the at least one thermoplastic plastic of the outer layer is at least one polyamide, and if the outer layer especially preferably consists or essentially consists of the at least one polyamide, it is very preferred that the at least one thermoplastic plastic of the adhesion promoter layer is at least one polyamide. In this conjunction, it is further preferred that the adhesion promoter layer then consists or essentially consists of the at least one adhesion-modified polyamide. As a result—in particular due to the varietal uniformity—the adhesion between the adhesion promoter layer and the outer layer can be further improved.

According to the present disclosure, the at least one thermoplastic plastic of the adhesion promoter layer is adhesion-modified, and for this purpose has at least one adhesion promoter group incorporated into the polymer structure and/or at least one adhesion promoter additive. It is very preferred that the at least one adhesion promoter additive is an adhesion promoter additive selected from the group: “silanes, halogenated polyolefins, in particular chlorinated polyolefins, acrylate-modified polyolefins, in particular acrylate-modified polypropylene and/or acrylate-modified polyethylene”. An adhesion promoter layer in which the thermoplastic plastic has at least one corresponding adhesion promoter additive can be used to realize an especially functionally reliable adhesion between the inner pipe and the outer layer. According to a preferred embodiment, the at least one adhesion promoter additive is at least one silane and/or at least one halogenated polyolefin and/or at least one acrylate-modified polyolefin. If the at least one adhesion promoter additive is a halogenated polyolefin, in particular a chlorinated polyolefin, then it is preferably a chlorinated polypropylene and/or chlorinated polyethylene.

According to a very preferred embodiment of the present disclosure, the at least one adhesion promoter additive is at least one silane, wherein the silane is preferably a silane selected from the group: “aminosilanes, epoxysilanes, vinylsilanes”. The at least one adhesion promoter additive is preferably at least one aminosilane and/or at least one epoxysilane and/or at least one vinylsilane. Silanes have proven especially effective as an adhesion promoter additive for modifying the adhesion of the at least one thermoplastic plastic of the adhesion promoter layer, and the use of silanes, in particular aminosilanes and/or epoxysilanes and/or vinylsilanes, as the adhesion promoter additive enables an especially functionally reliable adhesion between the inner pipe and the outer layer due to the interspersed adhesion promoter layer. With regard to adhesion, silanes enable in particular very advantageous interactions between the inner pipe and the adhesion promoter layer on the one hand, and in particular also between the adhesion promoter layer and the outer layer on the other hand.

Within the framework of the present disclosure, it is very preferred that the at least one adhesion promoter additive is at least one organofunctional silane. If the at least one adhesion promoter additive according to the preferred embodiment is at least one aminosilane, it is very preferred that it is difunctional aminosilane and/or a trifunctional aminosilane. The aminosilane is very preferably N-(2-aminoethyl)-3-aminopropylmethyldimethoxysilane and/or (3-aminopropyl)triethoxysilane and/or (3-aminopropyl)trimethoxysilane. These silanes have proven especially effective with respect to adhesion between the inner pipe and outer layer. If the at least one adhesion promoter additive according to the preferred embodiment is at least one epoxysilane, it is preferred that it is (3-glycidyloxypropyl)trimethoxysilane and/or (3-glycidyloxypropyl)triethoxysilane. These silanes have proven especially effective with respect to adhesion between the inner pipe and outer layer. If the at least one adhesion promoter additive according to the preferred embodiment is at least one vinylsilane, it is very preferred that it is vinyltrimethoxysilane and/or vinyltriethoxysilane. These silanes have proven especially effective with respect to adhesion between the inner pipe and outer layer.

In a very preferred embodiment of the pipeline according to the present disclosure, the thermoplastic plastic of the adhesion promoter layer contains 0.1 to 8.0 wt.-%, in particular 0.2 to 6.0 wt.-%, preferably 0.3 to 5.0 wt.-%, preferably 0.35 to 4.0 wt.-%, especially preferably 0.4 to 3.5 wt.-%, very preferably 0.5 to 3.0 wt.-% of the at least one adhesion promoter additive. This embodiment is based on the knowledge that a functionally reliable adhesive modification of the thermoplastic plastic of the adhesion promoter layer can nonetheless be achieved with a comparatively small portion of the adhesion promoter additive, and that a very advantageous adhesion can in this way be realized between the inner pipe and the outer layer by means of the adhesion promoter layer according to the present disclosure. The adhesion promoter layer preferably consists of the thermoplastic plastic or the adhesion-modified thermoplastic plastic.

According to a preferred embodiment of the present disclosure, the at least one thermoplastic plastic of the adhesion promoter layer has at least one filler, wherein the at least one filler is preferably a silicon dioxide, in particular in the form of silicon dioxide nanoparticles, and/or a nanocomposite material. The thermoplastic plastic of the adhesion promoter layer preferably has 0.5 wt.-% to 10 wt.-%, preferably 1.0 wt.-% to 5 wt.-%, preferably 1.5 wt.-% to 3.5 wt.-% of the at least one filler. This embodiment is based on the knowledge that the adhesion between the inner pipe and the outer layer can be further improved with the at least one filler, which the adhesion-modified thermoplastic plastic of the adhesion promoter layer preferably additionally has. The fillers are here in particular embedded into the matrix formed by the thermoplastic plastic, so as to increase the surface energy of the thermoplastic plastic, and in this way contribute to a further improvement in the adhesion between the outer layer and the inner pipe. It also lies within the framework of the present disclosure that the at least one adhesion promoter additive itself is a silicon dioxide, in particular in the form of silicon dioxide nanoparticles, and/or a nanocomposite material.

According to the present disclosure, the at least one thermoplastic plastic of the adhesion promoter layer is adhesion-modified, and for this purpose has at least one adhesion promoter group incorporated into the polymer structure and/or at least one adhesion promoter additive. It is possible that the at least one adhesion promoter group of the thermoplastic plastic of the adhesion promoter layer contains at least one hydroxy group and/or at least one acrylic acid group and/or at least one acrylic acid derivative group and/or at least one maleic acid group and/or at least one maleic acid derivative group and/or at least one halogenide group and/or at least one silane group.

It is preferred that the at least one adhesion promoter group of the thermoplastic plastic of the adhesion promoter layer is selected from the group: “Hydroxy group, acrylic acid, acrylic acid derivative, in particular acrylate, maleic acid, maleic acid derivative, in particular maleic acid anhydride, halogenide, silane”. According to a preferred embodiment, the at least one adhesion promoter group is incorporated into the polymer structure of the at least one thermoplastic plastic of the adhesion promoter layer via copolymerization and/or graft copolymerization and/or substitution. The at least one adhesion promoter group of the thermoplastic plastic of the adhesion promoter layer is very preferably at least one hydroxy group and/or at least one acrylic acid group and/or at least one acrylic acid derivative group and/or at least one maleic acid group and/or at least one maleic acid derivative group and/or at least one maleic acid anhydride group and/or at least one halogenide group and/or at least one silane group. According to an embodiment, the thermoplastic plastic of the adhesion promoter layer is grafted with maleic acid anhydride. According to a preferred embodiment, the at least one adhesion-modified thermoplastic plastic of the adhesion promoter layer is maleic acid anhydride-grafted polypropylene.

In terms of adhesion, incorporating the aforementioned adhesion promoter groups into the polymer structure of the thermoplastic plastic of the adhesion promoter layer enables advantageous interactions between the adhesion promoter layer and the inner layer, and in particular also between the adhesion promoter layer and the outer layer.

It is preferred that the wall thickness of the inner pipe is larger than the layer thickness of the outer layer. It is further preferred that the wall thickness of the inner pipe is larger than the layer thickness of the adhesion promoter layer. According to a preferred embodiment, the layer thickness of the outer layer is larger than the layer thickness of the adhesion promoter layer. The adhesion promoter layer thus preferably has a smaller layer thickness than the layer thickness of the outer layer and/or than the wall thickness of the inner pipe. Within the framework of the present disclosure, the terms wall thickness and layer thickness in particular refer to the largest expansion of the pipe or the corresponding layer transverse, in particular perpendicular or essentially perpendicular, to the longitudinal direction of the pipeline.

In a preferred embodiment of the pipeline according to the present disclosure, the layer thickness of the adhesion promoter layer is 7 μm to 300 μm, preferably 10 μm to 200 μm, preferably 12 μm to 100 μm, very preferably 12 μm to 50 μm, especially preferably 15 μm to 40 μm. It is very preferred that the layer thickness of the adhesion promoter layer is more than 1 μm, in particular more than 3 μm, preferably more than 5 μm, preferably more than 7 μm, very preferably more than 10 μm, especially preferably more than 12 μm, very especially preferably more than 15 μm, for example more than 20 μm and/or less than 300 μm, in particular less than 250 μm, preferably less than 200 μm, preferably less than 150 μm, further preferably less than 100 μm, very preferably less than 80 μm, very preferably less than 50 μm, especially preferably less than 40 μm, very especially preferably less than 30 μm.

It is preferred that the layer thickness of the outer layer is 50 μm to 300 μm, preferably 80 μm to 250 μm, preferably 100 μm to 200 μm, especially preferably 150 μm to 180 μm.

It is preferred that the inner pipe has a wall thickness of 500 μm to 1500 μm, preferably of 600 μm to 1200 μm, very preferably of 650 μm to 1100 μm, especially preferably of 680 μm to 1050 μm.

Within the framework of the present disclosure, it is especially preferred that the overall thickness d of the pipe wall is 500 μm to 2000 μm, preferably 700 μm to 1500 μm, preferably 750 μm to 1300 μm, especially preferably 800 μm to 1200 μm. Overall thickness d of the pipe wall here refers in particular to the largest expansion of the entirety of the layers of the pipe wall, including the wall thickness of the inner pipe transverse, in particular perpendicular or essentially perpendicular, to the longitudinal direction of the pipeline.

According to an especially recommended embodiment of the present disclosure, the wall thickness of the inner pipe is 55% to 95%, preferably 65% to 90%, preferably 75% to 85% of the overall thickness d of the pipe wall. The layer thickness of the outer layer very preferably is 5% to 30%, preferably 10% to 25%, preferably 12% to 22%, very preferably 13% to 20%, of the overall thickness d of the pipe wall. It is especially preferred that the layer thickness of the adhesion promoter layer is 0.5 to 8.0%, preferably 1.0% to 7.0%, very preferably 1.5% to 5.0%, especially preferably 2.0% to 4.0%, of the overall thickness d of the pipe wall.

It is preferred that the adhesion promoter layer is extruded onto the inner pipe and/or that the outer layer is extruded onto the adhesion promoter layer. The adhesion promoter layer and the outer layer are very preferably coextruded onto the inner pipe.

In order to solve the technical problem, the present disclosure also teaches the use of a motor vehicle pipeline according to the present disclosure as a brake line in a motor vehicle.

In order to solve the technical problem, the present disclosure further teaches a method for manufacturing a motor vehicle pipeline, in particular a motor vehicle pipeline described above, wherein an inner pipe made of at least one metal is provided, wherein at least one adhesion promoter layer made of at least one thermoplastic plastic is extruded onto an outer surface of the inner pipe, wherein the at least one thermoplastic plastic of the adhesion promoter layer is adhesion-modified, and for this purpose has at least one adhesion promoter group incorporated into the polymer structure and/or at least one adhesion promoter additive, and wherein at least one outer layer made of at least one thermoplastic plastic is applied, in particular extruded, onto an outer surface of the adhesion promoter layer, and wherein the adhesion promoter layer and the outer layer are preferably coextruded.

Within the framework of the method according to the present disclosure, the at least one adhesion promoter layer is extruded onto the inner pipe, and the at least one outer layer is preferably extruded onto the adhesion promoter layer. This is associated with special advantages in terms of manufacturing the pipeline, since the complicated steps previously known from practice for applying a primer layer can be avoided within the framework of the method according to the present disclosure. In a preferred embodiment of the method according to the present disclosure, the adhesion promoter layer and the outer layer are coextruded, and in particular coextruded onto the inner pipe.

The present disclosure is based on the knowledge that the motor vehicle pipeline according to the present disclosure is characterized by a very functionally reliable adhesion between the inner pipe and the outer layer, which is realized by the at least one adhesion promoter layer according to the present disclosure made of at least one thermoplastic plastic arranged or interspersed between the inner pipe and the outer layer, wherein the at least one thermoplastic plastic of the adhesion promoter layer is adhesion-modified. The adhesion promoter layer according to the present disclosure made of at least one adhesion-modified thermoplastic plastic makes it possible to avoid the measures known from practice, in which a primer layer, for example made of a thermosetting epoxy resin, must be applied in a complicated manner. According to the present disclosure, an adhesion promoter layer made of at least one adhesion-modified thermoplastic plastic is used, making it possible in this way to easily and functionally reliably ensure the adhesion between the outer layer and the inner pipe. Adhesion problems between the outer layer and the inner pipe can be very reliably avoided in this way. In order to modify adhesion, the thermoplastic plastic of the adhesion promoter layer has at least one adhesion promoter group incorporated into the polymer structure and/or at least one adhesion promoter additive. According to a preferred embodiment, the adhesion promoter layer is extruded onto the inner pipe. According to a further preferred embodiment, the outer layer is extruded onto the adhesion promoter layer. In this regard, the pipeline according to the present disclosure is preferably characterized by a very simple manufacture, and in particular has a low cost and low effort design. According to another preferred embodiment, the adhesion promoter layer and the outer layer can be coextruded together onto the inner pipe. As a whole, the pipeline according to the present disclosure can be manufactured with low-cost measures, and the pipeline as well as the corresponding manufacturing process are also advantageous from an environmental standpoint.

According to an especially preferred embodiment of the present disclosure, the pipeline has the inner pipe and at least two (additional) layers, preferably the inner pipe and two (additional) layers, specifically with the following structural design from the inside out: Inner pipe made of at least one metal, in particular of aluminum/adhesion promoter layer made of at least one adhesion-modified thermoplastic plastic, in particular of at least one adhesion-modified polypropylene and/or of at least one adhesion-modified polyamide/outer layer made of at least one thermoplastic plastic, in particular of at least one polypropylene and/or of at least one polyamide. In particular polyamide 6.12 and/or polyamide 12 are preferred as polyamides for the adhesion promoter layer and/or for the outer layer.

### BRIEF DESCRIPTION OF THE DRAWINGS

The present disclosure will be explained in more detail below based on a drawing, which only depicts an exemplary embodiment. Schematically shown on:

FIG. 1 is a perspective view of a motor vehicle pipeline according to the present disclosure, and

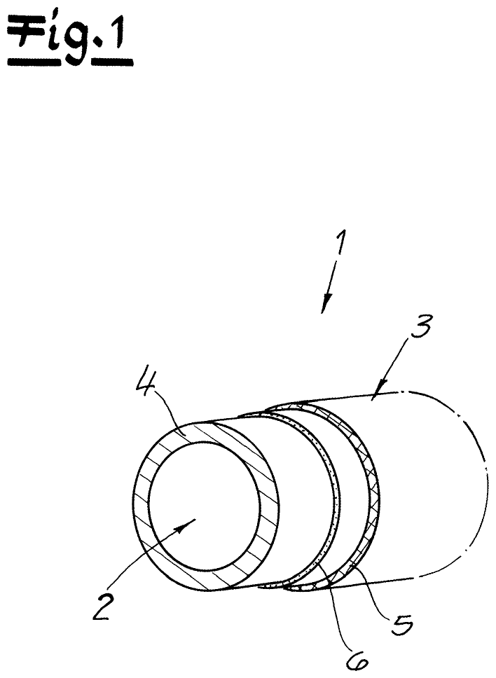

FIG. 2 is a section through the object according to FIG. 1.

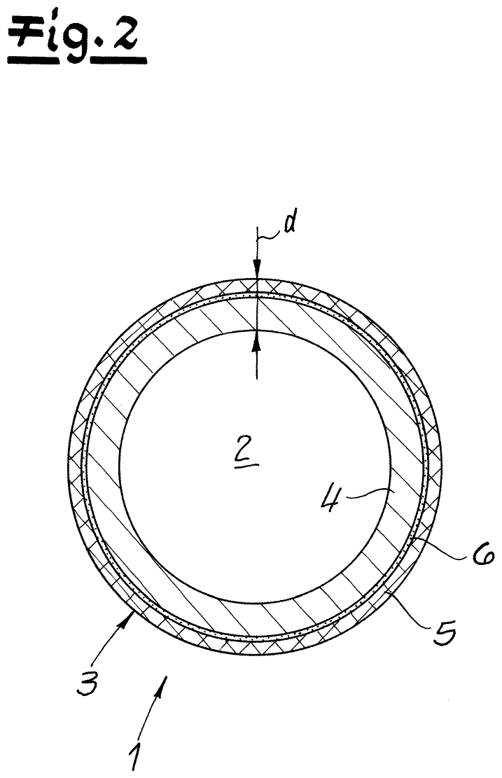

### DETAILED DESCRIPTION

The figures show a motor vehicle pipeline 1 according to the present disclosure. In the exemplary embodiments according to the figures, this pipeline 1 can be a brake line for motor vehicles. According to the present disclosure, the pipeline 1 has a fluid channel 2 and a pipe wall 3 surrounding the fluid channel 2. A fluid medium, in particular a brake fluid, is carried through the pipeline 1 in the fluid channel 2, and not shown in any more detail on the figures.

The pipe wall 3 of the pipeline 1 shown on the figures has an inner pipe 4 made of at least one metal and an outer layer 5 made of at least one thermoplastic plastic that encases the inner pipe 4. At least one, preferably one as in the exemplary embodiment, adhesion promoter layer 6 made of at least one thermoplastic plastic is arranged between the inner pipe 4 and the outer layer 5, wherein the thermoplastic plastic of this adhesion promoter layer 6 is adhesion-modified. The thermoplastic plastic of the adhesion promoter layer 6 can preferably have at least one adhesion promoter additive for modifying adhesion, as in the exemplary embodiment according to the figures.

The inner pipe 4 preferably consists of aluminum or essentially of aluminum, as in the exemplary embodiment according to the figures. The adhesion promoter layer 6 preferably outwardly adjoins the inner pipe 4, as in the exemplary embodiment according to the figures. The thermoplastic plastic of the adhesion promoter layer 6 is preferably at least one polyamide. In the exemplary embodiment according to the figures, it can be polyamide 6.12. It is very preferred that the adhesion promoter layer 6 consists of the adhesion-modified polyamide 6.12 or essentially consists of the adhesion-modified polyamide 6.12, as in the exemplary embodiment according to the figures. In order to modify the adhesion of the thermoplastic plastic of the adhesion promoter layer 6 or the polyamide 6.12, the thermoplastic plastic of the adhesion promoter layer 6 or the polyamide 6.12 can preferably, and in the exemplary embodiment, have at least one silane as the adhesion promoting additive and very preferably at least one aminosilane and very especially preferably (3-aminopropyl)trimethoxysilane. The thermoplastic plastic of the adhesion promoter layer 6 or the polyamide 6.12 preferably has 0.4 to 4.0 wt.-% of the at least one adhesion promoter additive or the at least one aminosilane. In the exemplary embodiment according to the figures, the thermoplastic plastic of the adhesion promoter layer 6 or the adhesion promoter layer 6 for modifying the adhesion can have 2.5 wt.-% of the adhesion promoter additive or the aminosilane.

The outer layer 5 preferably outwardly adjoins the adhesion promoter layer 6, as in the exemplary embodiment according to the figures. The at least one thermoplastic plastic of the outer layer 5 is preferably a polyamide, and very especially preferably and in the exemplary embodiment polyamide 6.12. The outer layer preferably consists of the at least one polyamide or of polyamide 6.12 or essentially consists thereof, as in the exemplary embodiment according to the figures.

In the exemplary embodiment, the outer layer 5 is preferably the outwardly terminal layer of the pipeline 1, and the inner pipe 4 inwardly forms the termination of the pipeline 1. According to a preferred embodiment of the present disclosure, the overall thickness d of the pipe wall 3 is 800 μm to 1200 μm. In the exemplary embodiment according to the figures, the overall thickness d of the pipe wall 3 is about 1100 μm. In the exemplary embodiment according to the figures, the wall thickness of the inner pipe 4 is expediently larger than the layer thickness of the outer layer 5, and larger than the layer thickness of the adhesion promoter layer 6. In the exemplary embodiment, it is further preferred that the layer thickness of the outer layer 5 is larger than the layer thickness of the adhesion promoter layer 6. It is preferred that the layer thickness of the adhesion promoter layer 6 is 12 μm to 50 μm. The layer thickness of the adhesion promoter layer 6 can preferably be 30 μm, as in the exemplary embodiment according to the figures. The layer thickness of the outer layer 5 further preferably is 150 μm to 180 μm. In the exemplary embodiment according to the figures, the layer thickness of the outer layer 5 can be 170 μm. It is preferred that the inner pipe has a wall thickness of 680 μm to 1050 μm. In the exemplary embodiment according to the present disclosure, the wall thickness of the inner pipe 4 can preferably is 900 μm.

1. A pipeline for forming a brake line for motor vehicles, for conveying at least one fluid medium, wherein the pipeline has a fluid channel and a pipe wall surrounding the fluid channel, and wherein the pipe wall has an inner pipe made of at least one metal and an outer layer made of at least one thermoplastic plastic that encases the inner pipe, wherein at least one adhesion promoter layer made of at least one thermoplastic plastic is arranged between the inner pipe and the outer layer, and wherein the at least one thermoplastic plastic of the adhesion promoter layer is adhesion-modified and has at least one adhesion promoter group incorporated into the polymer structure and/or at least one adhesion promoter additive.

2. The pipeline according to claim 1, wherein the inner pipe contains aluminum and/or zinc and/or iron, wherein the inner pipe is formed on the basis of aluminum and/or on the basis of zinc and/or on the basis of iron, and/or on the basis of steel,.

3. The pipeline according to claim 1, wherein the at least one thermoplastic plastic of the outer layer is at least one polypropylene, and/or at least one homo-polypropylene and/or at least one polypropylene copolymer, and wherein the outer layer essentially consists of the at least one polypropylene.

4. The pipeline according to claim 1, wherein the at least one thermoplastic plastic of the outer layer is at least one polyamide selected from the group: polyamide 6, polyamide 10, polyamide 11, polyamide 12, polyamide 6.6, polyamide 6.10, polyamide 6.12, polyamide 6.16, polyamide 10.10, and wherein the outer layer essentially consists of the at least one polyamide.

5. The pipeline according to claim 1, wherein the at least one thermoplastic plastic of the adhesion promoter layer is at least one polypropylene, and/or least one homo-polypropylene and/or at least one polypropylene copolymer.

6. The pipeline according to claim 1, wherein the at least one thermoplastic plastic of the adhesion promoter layer is at least one polyamide selected from the group: polyamide 6, polyamide 10, polyamide 11, polyamide 12, polyamide 6.6, polyamide 6.10, polyamide 6.12, polyamide 6.16, polyamide 10.10.

7. The pipeline according to claim 1, wherein the at least one adhesion promoter additive is at least one adhesion promoter additive selected from the group: silanes, halogenated polyolefins, in particular chlorinated polyolefins, acrylate-modified polyolefins, in particular acrylate-modified polypropylene and/or acrylate-modified polyethylene.

8. The pipeline according to claim 1, wherein the at least one adhesion promoter additive is at least one silane selected from the group: aminosilanes, epoxysilanes, vinylsilanes.

9. The pipeline according to claim 1, wherein the thermoplastic plastic of the adhesion promoter layer contains 0.5 to 3.0 wt.-% of the at least one adhesion promoter additive.

10. The pipeline according to claim 1, wherein the at least one thermoplastic plastic of the adhesion promoter layer has at least one filler, wherein the at least one filler is preferably a silicon dioxide in the form of silicon dioxide nanoparticles, and/or a nanocomposite material.

11. The pipeline according to claim 1, wherein the at least one adhesion promoter group of the thermoplastic plastic of the adhesion promoter layer is selected from the group: hydroxy group, acrylic acid, acrylic acid derivative, in particular acrylate, maleic acid, maleic acid derivative, in particular maleic acid anhydride, halogenide, silane.

12. The pipeline according to claim 1, wherein the layer thickness of the adhesion promoter layer is 15 μm to 40 μm.

13. The pipeline according to claim 1, wherein the layer thickness of the outer layer is 150 μm to 180 μm.

14. The pipeline according to claim 1, wherein the inner pipe has a wall thickness of 680 μm to 1050 μm.

15. The pipeline according to claim 1, wherein the overall thickness d of the pipe wall is 800 μm to 1200 μm.

16. A method for manufacturing the pipeline according to claim 1, wherein the inner pipe made of at least one metal is provided, wherein the at least one adhesion promoter layer made of at least one thermoplastic plastic is extruded onto an outer surface of the inner pipe, wherein the at least one thermoplastic plastic of the adhesion promoter layer is adhesion-modified and has at least one adhesion promoter group incorporated into the polymer structure and/or at least one adhesion promoter additive, and wherein the at least one outer layer made of at least one thermoplastic plastic is extruded onto an outer surface of the adhesion promoter layer, and wherein the adhesion promoter layer and the outer layer are coextruded.
